(19) United States
(12) Patent Application Publication
(10) Pub. No.: US 2019/0166420 A1
(43) Pub. Date: May 30, 2019

(54) UAS SURVEILLANCE AND COMMUNICATION PACKAGE

(71) Applicant: Packet Digital, LLC, Fargo, ND (US)

(72) Inventor: Andrew Paulsen, Fargo, ND (US)

(73) Assignee: Packet Digital, LLC, Fargo, ND (US)

(21) Appl. No.: 15/825,479

(22) Filed: Nov. 29, 2017

(51) Int. Cl. H04R 1/32; B64D 47/02; B64C 39/02; G08G 5/00

(52) U.S. Cl. CPC H04R 1/326; B64D 47/02; B64D 2203/00; G08G 5/0013; B64C 2201/146; B64C 39/024

(57) ABSTRACT

Embodiments of the present systems and methods may provide the capability to add capabilities to existing drones, with little or no modification of the drone itself. For example, in an embodiment, apparatus for enhancing operation of an unmanned aircraft system may comprise a controller comprising a processor, memory, and program instructions stored in the memory and executable by the processor, lighting apparatus controllable by the processor, audio apparatus controllable by the processor, communication circuitry communicatively connected to the controller to provide communication between the apparatus and an operator, and a power source, wherein the apparatus is adapted to be mounted to an unmanned aircraft system and to operate independently of the unmanned aircraft system.

### BACKGROUND

The present invention relates to apparatus for providing surveillance and bi-directional communication capabilities to unmanned aircraft systems.

Small Unmanned Aircraft Systems (sUASs), commonly known as drones, have the potential to enable a broad range of capabilities for tactical operators across a wide array of missions and environments. However, many drones marketed towards law enforcement organizations (LEOs) are made for outdoor, search-and-rescue style mission sets, and therefore are not equipped with sensors and payloads suitable for more sophisticated reconnaissance and tactical missions. In addition, traditional drones for law enforcement are often large, expensive, and require a significant amount of operator training; and many have ground control systems that are not easily man-portable.

Commercial drones are relatively inexpensive with relatively good flight performance. However, existing commercial drones provide relatively limited policing, peacekeeping, and surveillance capabilities. While commercial drones may be modified to improve such capabilities, these modifications may be relatively expensive and may negatively affect the performance parameters of the drone. Further, modifications must be made individually to each drones, which is time consuming and expensive.

A need arises for techniques by which additional capabilities may be added to existing drones, with little or no modification of the drone required.

### SUMMARY

Embodiments of the present systems and methods may provide the capability to add capabilities to existing drones, with little or no modification of the drone itself.

For example, in an embodiment, apparatus for enhancing operation of an unmanned aircraft system may comprise a controller comprising a processor, memory, and program instructions stored in the memory and executable by the processor, lighting apparatus controllable by the processor, audio apparatus controllable by the processor, communication circuitry communicatively connected to the controller to provide communication between the apparatus and an operator, and a power source, wherein the apparatus is adapted to be mounted to an unmanned aircraft system and to operate independently of the unmanned aircraft system.

In embodiments, the lighting apparatus may comprise illumination lighting devices and distraction/diversion lighting devices. The illumination lighting devices may comprise at least one of: at least one wide-beam visible light LED lamp and at least one infrared LED lamp and the distraction/diversion lighting devices comprise at least one of: at least one narrow-beam colored LED lamp and at least one wide-beam LED lamp operating in a strobing mode. The audio apparatus may comprise at least one microphone and at least one speaker. The at least one microphone may comprise at least one omni-directional microphone and at least one directional microphone. The audio apparatus may be adapted to provide at least one of: bi-directional communication between the operator and a subject and audible distraction.

In an embodiment, a system may comprise an unmanned aircraft system comprising an apparatus mounted to the unmanned aircraft system and independently operable from the unmanned aircraft system, the apparatus may comprise a controller comprising a processor, memory, and program instructions stored in the memory and executable by the processor, lighting apparatus controllable by the processor, audio apparatus controllable by the processor, communication circuitry communicatively connected to the controller to provide communication between the apparatus and a control device, and a power source, and a control device comprising a processor, memory, and program instructions stored in the memory and executable by the processor to provide a user interface for controlling the apparatus and communications with the apparatus.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary block diagram of major components of an enhanced drone system in accordance with embodiments of the present invention.

FIG. 2 illustrates an exemplary block diagram of an accessory payload in accordance with embodiments of the present invention.

FIG. 3 is an exemplary schematic diagram of accessory payload in accordance with embodiments of the present invention.

FIG. 4 is an exemplary block diagram of a controller in accordance with embodiments of the present invention.

### DETAILED DESCRIPTION

Embodiments of the present systems and methods may provide the capability to add capabilities to existing UASs, with little or no modification of the UAS itself.

Embodiments of the present systems and methods may provide a solution to fill the need for a capable, cost-effective UAS for use in, for example, tactical situations. In embodiments, the present systems and methods may provide the capability to quickly capture, process, and distribute audio and video data to support tactical operations and decision making in a variety of environments and situations, as well as providing communication, tactical distraction and operational mapping capabilities.

Embodiments of the present systems and methods may provide audio sensors, radios, speakers, and emitters designed for audio surveillance and/or bi-directional communication with a target. Additional features may provide low-light video and photography operations. A tactical distraction mode may give operators the edge when engaging a perpetrator. The combined package gives tactical teams ultimate flexibility during all phases of operations.

Embodiments of the present systems and methods may utilize commercially available drones, such as the DJI™ Mavic Pro, which may lower the initial cost of the system, thereby reducing the financial risks and allowing greater flexibility in system employment.

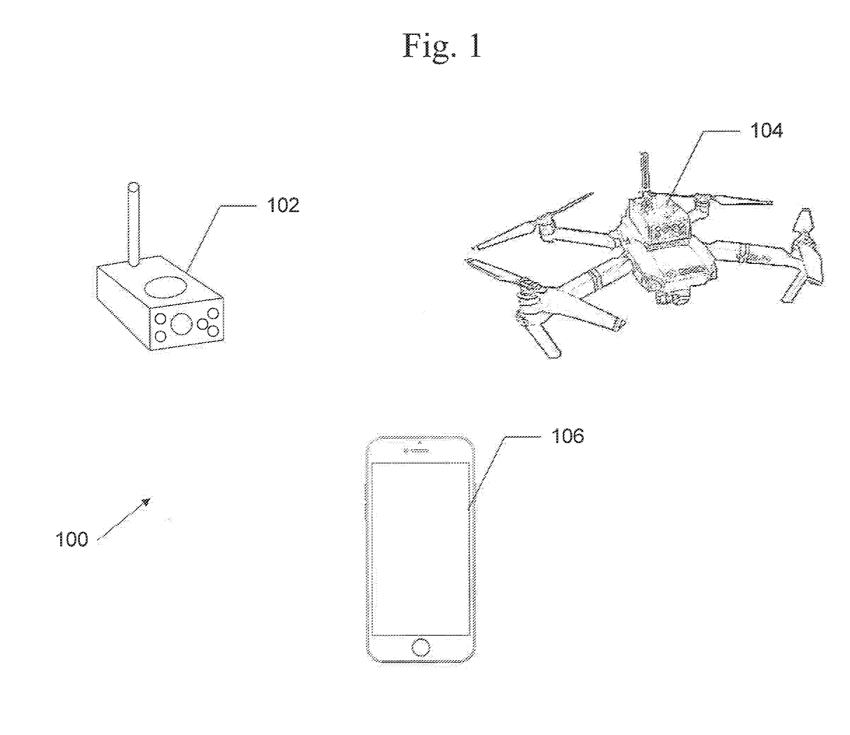

An example of major components of an enhanced drone system 100 is shown in FIG. 1. System 100 may include an accessory payload 102, a drone or drone 104 (shown with accessory payload 102 attached), and a control device 106. Accessory payload 102 may be a self-contained electronic system that may be attached to drone 104. Accessory payload 102 may provide capabilities such as audio surveillance and/or bi-directional communication, low-light video and photography operations, and tactical distractions. The drone 104 may be any drone with sufficient payload capacity to carry accessory payload 102. For example, drone 104 may be a standard, commercially available drone, a proprietary drone, a custom-made or customized drone, or any other drone having the appropriate payload capacity to carry the accessory payload.

Control device 106 may be an electronic system that provides a user interface to operate accessory payload 102. For example, control device 106 may be a tablet or tablet computer, a smartphone, a personal computer, a custom-made device, or any other electronic device that includes communication and user-interface capabilities. Control device 106 may be used to control drone 104 as well as accessory payload 102 using a custom app or using a web app. In either case, the app may provide intuitive drone control and aerial data capture and delivery, designed to help drone users react quickly to changing conditions. The app may feature an intuitive drag-and-drop mission planning, auto takeoffs and landings, and point-to-point navigation that put the operator in complete control according to FAA guidelines. During flight, the app may display radio signal strength, 3D position, and various other flight information from drone 104. When used in conjunction with the drone 104 manual controller, the app can display real-time video and still images to provide instant information from a scene or operation. The app may feature cloud-based data processing, distribution and storage. It may photostitch individual image files into high-definition 2D orthomosaics and 3D models, sync the processed data to common industry software, distribute it to colleagues, store and index files according to date and worksite, and be used to markup and annotate files online.

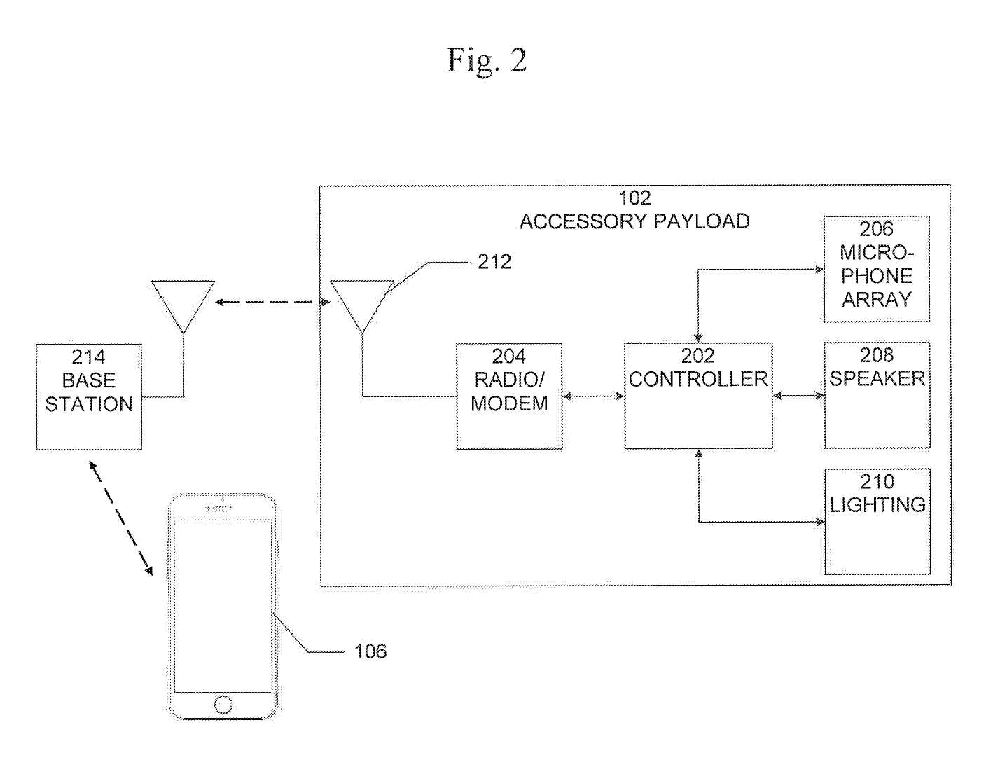

An exemplary block diagram of an accessory payload 102 is shown in FIG. 2. It is best viewed in conjunction with FIG. 1. In this example, accessory payload 102 may include controller 202, radio/modem 204, microphone array 206, speaker 208, lighting 210, and antenna 212. Accessory payload 102 may be communicatively connected to control device 106 via base station 214. Controller 202 may be, for example, a single-chip or embedded microprocessor or controller, including, for example, memory storing program instructions and data, input/output circuitry, and control circuitry. Radio/modem 204 may include wireless radio frequency transceiver circuitry, for transmitting and receiving communications and control signals wirelessly with base station 214. In embodiments, this may be a long-range 900 MHz radio. Radio/modem 204 may be provided in addition to original drone radio in order to supply adequate bandwidth for surveillance, communications, and payload control from a safe distance out of harm's way.

Base station 214 may include or be connected to wireless radio frequency transceiver circuitry, for transmitting and receiving communications and control signals wirelessly with accessory payload 102. Wireless communications may be provided on any suitable frequency. For example, the 900 MHz frequency band may be used. Base station 214 may further be communicatively connected to control device 106 over a wired or wireless communication connection, and may further transmit and receive communications and control signals with control device 106.

Microphone array 206 may include one or more directional or omni-direction microphones for receiving sounds audible in the vicinity of the drone 104 to which accessory payload 102 is attached. Speaker 208 may include one or more speakers for transmitting sounds to the vicinity of the drone 104 to which accessory payload 102 is attached. Microphone array 206 and speaker 208 may be connected to controller 202 through analog and digital circuitry that may provide the capability to convert received digital signals into audio signals for transmission by speaker 208 and to convert audio signals from microphone array 206 to digital signals for transmission. Lighting 210 may include light sources, such as LED lamps to provide illumination, or additional illumination.

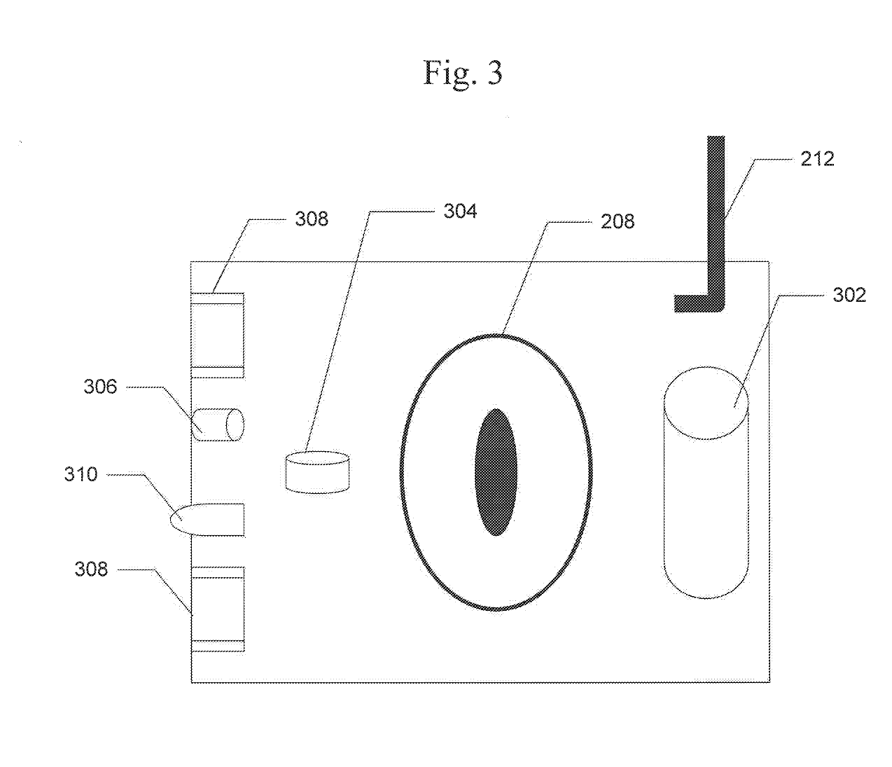

An exemplary schematic diagram of accessory payload 102 is shown in FIG. 3. It is best viewed in conjunction with FIG. 2. In this example, the components shown include antenna 212, battery 302, speaker 208, microphone array 206, which may include omni-directional microphone 304 and directional microphone 306, and lighting 210, which may include illumination lighting 308 and distraction lighting 310.

In embodiments, microphone array 206 may include an omni-directional microphone 304 with noise-cancelling filters for capturing surround-sound audio from a site or crime scene while blocking the hum from drone motors and propellers. In embodiments, omni-directional microphone 304 may be mounted at the top of accessory payload 102 in order to enhance the omni-directional characteristics of the microphone. Microphone array 206 may also include a directional microphone 306 with noise filters for collecting more targeted audio from a specific location or individual. In embodiments, directional microphone 306 may be mounted at the front of accessory payload 102 in order to enhance the directional characteristics of the microphone. Speaker 208 may provide bi-directional communication between the operator using control device 106 and the subject under surveillance when traditional means of long-distance communication like phone or two-way radio are unavailable, or when otherwise desired. Further, speaker 208 may provide audible distraction of individuals and/or groups.

Accessory payload 102 may provide daylight and low-light photo and video surveillance capabilities. For example, typical drones include standard cameras. Accessory payload 102 may include lighting 210 to provide illumination, or additional illumination. In embodiments, lighting 210 may include illumination lighting 308, for example, one or more superbright LEDs to provide adequate light in any after-dark situation. In embodiments, illumination lighting 308 may include one or more Infrared (IR) LEDs to provide a light source that is imperceptible to the human eye and night-vision-like photo and video collection. In embodiments, lighting 210 may include distraction lighting 310, for example, one or more LEDs that may provide visual distraction of individuals and/or groups. In embodiments, the LEDs may be red, or other color, narrow beam LEDs that may be aimed at particular individuals. The LEDs may be high-intensity, narrow-beam, red LEDs that may be aimed to distract or disorient a person without blinding. This distraction feature may be used prior to approaching or engaging a target at critical stages of a standoff or other tactical operation. It is to be further noted, that, in embodiments, illumination lighting 308 may also be strobed in order to provide visual distraction or diversion of individuals and/or groups

In embodiments, further features of accessory payload 102 may include:

LOW-POWER OPERATION—Accessory payload 102 may operate independently from the main battery and power supply of the drone. Running on its own battery power, for example, a single, lightweight CRI23A 3V battery, accessory payload 102 may provide audio and video surveillance, bi-directional communication, illumination and tactical distraction at varying intervals for operations lasting more than 30 minutes.

TACTICAL MAPPING OPERATIONS—Accessory payload 102, in conjunction with the drone may provide the capability of quickly producing high-quality overhead maps and 3D models for use in tactical mission planning and execution. These maps may be imported into a variety of mapping and planning tools for integration with existing workflows.

INDOOR AND OUTDOOR OPERATIONS—The drone may typically be designed for both indoor and outdoor operations. It may fly GPS-guided pre-planned missions, as well as indoors using precision station-keeping cameras and manual controls through the bundled controller. The software system may allow users to pre-plan missions, as well as monitor the drone during manual flight operations.

LOWER SYSTEM COSTS—By creating a single upgrade module for an existing, affordable, commercially available drone, accessory payload 102 may reduce the acquisition costs to adopt this technology. A complete tactical operations package may be provided, including a mapping and modeling platform on a drone that can be used both indoors and outdoors. This means less equipment and user training, further reducing costs and time for implementation.

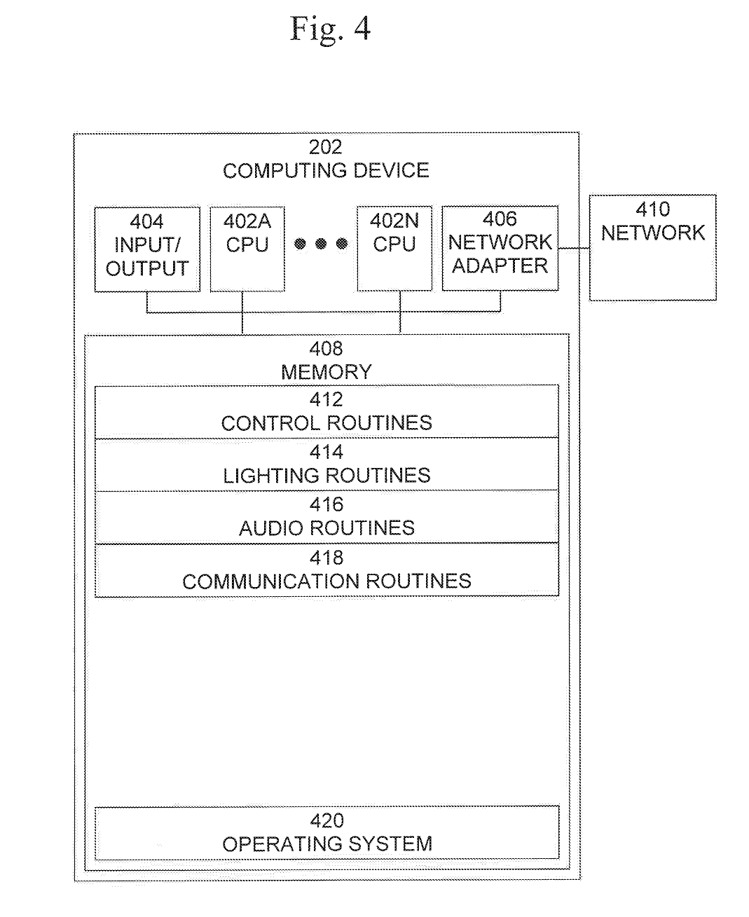

An exemplary block diagram of a controller 202, in which processes involved in the embodiments described herein may be implemented, is shown in FIG. 4. Controller 202 may be implemented using one or more programmed general-purpose computing devices, such as an embedded processor or a system on a chip. Controller 202 may include one or more processors (CPUs) 402A-402N, input/output circuitry 404, network adapter 406, and memory 408. CPUs 402A-402N execute program instructions in order to carry out the functions of the present communications systems and methods. Typically, CPUs 402A-402N are one or more processor cores. FIG. 4 illustrates an embodiment in which controller 202 is implemented as a single multi-core computer computing device, in which multiple processors 402A-402N share system resources, such as memory 408, input/output circuitry 404, and network adapter 406. However, the present communications systems and methods may also include other embodiments.

Input/output circuitry 404 provides the capability to input data to, or output data from, controller 202. For example, input/output circuitry may include input devices, such as microphones, keyboards, mice, touchpads, trackballs, scanners, analog to digital converters, etc., output devices, such as speakers, lighting devices, video adapters, monitors, printers, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of controller 202. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 may vary depending upon the function that controller 202 is programmed to perform. In the example shown in FIG. 4, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In the example shown in FIG. 4, memory 408 may include control routines 412, lighting routines 414, audio routines 416, communication routines 418, and operating system 420. Control routines 412 may include software routines that may provide the capability to control processing in controller 202 and to control the operation of accessory payload 102. Lighting routines 414 may include software routines that may provide the capability to control the operation of lighting 210, including illumination, strobing, and distraction/diversion modes of operation. Audio routines 416 may include software routines that may provide the capability to control audio input and output of accessory payload 102, including one-way audio output, one-way audio input, two-way audio operation, and distraction/diversion audio operation. Communication routines 418 may include software routines that may provide the capability to communicate with control device 106 via base station 214. Operating system 420 may provide overall system functionality.

As shown in FIG. 4, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2@, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. Apparatus for enhancing operation of an unmanned aircraft system comprising:
a controller comprising a processor, memory, and program instructions stored in the memory and executable by the processor;
lighting apparatus controllable by the processor,
audio apparatus controllable by the processor;
communication circuitry communicatively connected to the controller to provide communication between the apparatus and an operator; and
a power source;
wherein the apparatus is adapted to be mounted to an unmanned aircraft system and to operate independently of the unmanned aircraft system.

2. The apparatus of claim 1, wherein:
the lighting apparatus comprises illumination lighting devices and distraction/diversion lighting devices.

3. The apparatus of claim 2, wherein:
the illumination lighting devices comprise at least one of: at least one wide-beam visible light LED lamp and at least one infrared LED lamp;
and the distraction/diversion lighting devices comprise at least one of: at least one narrow-beam colored LED lamp and at least one wide-beam LED lamp operating in a strobing mode.

4. The apparatus of claim 2, wherein the audio apparatus comprises at least one microphone and at least one speaker.

5. The apparatus of claim 4, wherein the at least one microphone comprises at least one omni-directional microphone and at least one directional microphone.

6. The apparatus of claim 2, wherein the audio apparatus is adapted to provide at least one of: bi-directional communication between the operator and a subject and audible distraction.

7. A system comprising:
an unmanned aircraft system comprising an apparatus mounted to the unmanned aircraft system and independently operable from the unmanned aircraft system, the apparatus comprising:
a controller comprising a processor, memory, and program instructions stored in the memory and executable by the processor,
lighting apparatus controllable by the processor,
audio apparatus controllable by the processor,
communication circuitry communicatively connected to the controller to provide communication between the apparatus and a control device, and
a power source; and
a control device comprising:
a processor, memory, and program instructions stored in the memory and executable by the processor to provide a user interface for controlling the apparatus and communications with the apparatus.

8. The system of claim 7, wherein:
the lighting apparatus comprises illumination lighting devices and distraction/diversion lighting devices.

9. The system of claim 8, wherein:
the illumination lighting devices comprise at least one of: at least one wide-beam visible light LED lamp and at least one infrared LED lamp;
and the distraction/diversion lighting devices comprise at least one of: at least one narrow-beam colored LED lamp and at least one wide-beam LED lamp operating in a strobing mode.

10. The system of claim 8, wherein the audio apparatus comprises at least one microphone and at least one speaker.

11. The system of claim 10, wherein the at least one microphone comprises at least one omni-directional microphone and at least one directional microphone.

12. The system of claim 8, wherein the audio apparatus is adapted to provide at least one of: bi-directional communication between the operator and a subject and audible distraction.
